(19) United States
(12) Patent Application Publication
(10) Pub. No.: US 2013/0168320 A1
(43) Pub. Date: Jul. 4, 2013

(54) ORGANIC TEMPLATED NANOMETAL OXYHYDROXIDE

(71) Applicants: Thalappil Pradeep, Chennai (IN); Mundampra Maliyekkal Shihabudheen, Kerala (IN); Anshup, Lucknow (IN); Mohan Udhaya Sankar, Cuddalore (IN); Chaudhary Amrita, Varanasi (IN)

(72) Inventors: Thalappil Pradeep, Chennai (IN); Mundampra Maliyekkal Shihabudheen, Kerala (IN); Anshup, Lucknow (IN); Mohan Udhaya Sankar, Cuddalore (IN); Chaudhary Amrita, Varanasi (IN)

(73) Assignee: INDIAN INSTITUTE OF TECHNOLOGY, Chennai (IN)

(21) Appl. No.: 13/701,561

(22) PCT Filed: Jun. 2, 2011
(86) PCT No.: PCT/IB11/01551

§ 371 Date: Feb. 19, 2013

(30) Foreign Application Priority Data
Jun. 2, 2010 (IN) 1529/CHE/2010

(51) Int. Cl. C02F 1/28

(52) U.S. Cl. CPC C02F 1/288
USPC 210/683; 428/402; 210/660; 210/688; 106/217.9; 106/204.01

(57) ABSTRACT

Disclosed are granular composites comprising a biopolymer and one or more nanometal-oxyhydroxide/hydroxide/oxide particles, along with methods for the preparation and use thereof.

### BACKGROUND

1. Technical Field

The present disclosure relates to nanomaterials, and particularly to nanometal oxyhydroxide materials, such as, for example, organic templated nanometal oxyhydroxide materials, together with methods of preparing such materials.

2. Technical Background

Amongst all aluminum based compositions, activated alumina is the most popular composition. Activated alumina is typically prepared by complete thermal dehydration of aluminum hydroxide whereas boehmite is typically prepared by partial thermal dehydration of aluminum hydroxide. Activated alumina is an effective industrial desiccant, catalyst support and an effective adsorbent of arsenic and fluoride in water. The United Nations Environmental Program agency (UNEP) classified activated alumina adsorption among the best available technologies for arsenic removal from water. Aluminum based compounds in general, and alumina in particular, are widely used and are the basis of demonstrated technology for removing arsenic and fluoride from drinking water. The fluoride adsorption capacity of aluminum based compounds, however, is typically very low, for example, on the order of 1 to 10 mg/g. Arsenic adsorption capacity is similarly low. Thus, adsorption technologies and devices which utilize conventional alumina materials are limited by the low arsenic and fluoride uptake capacity and can require frequent regeneration, producing large amounts of solid and liquid waste.

Typically, granular beads of alumina are used in the applications discussed above. Powder based compositions cannot be directly used due to the inherent poor hydraulic conductivity and the danger of particle leaching. The conventional granular beads are prepared by adding binders along with fine particles of alumina/aluminum hydroxide, and heating the mixture at elevated temperatures in the range of 300° C. to 600° C. Yet another method for obtaining alumina beads is via an oil-drop method wherein a gel obtained by precipitation of an aluminum precursor is allowed to drop into a hot oil bath, forming spherical particles and ageing the particles at higher pressure and temperature. The resulting crystalline spherical alumina particles are obtained after washing, drying and calcining at high temperature. Due to the use of external physical and/or chemical agents, such approaches are lesser environment friendly and uneconomical.

Metal oxide-chitosan composite materials are one example of organic bio-based materials known for their adsorption capacity to remove, for example, various aquatic pollutants. Ti—Al supported chitosan beads have recently been examined for the removal of fluoride, wherein it was found that chitosan beads dried at 80° C. swell in water and clog the filter unit. Calcining the beads at elevated temperature (e.g., 450° C.) can improve the stability of the beads; however, the calcination process reduces the fluoride uptake capacity and can decompose chitosan. These constraints restrict the use of such media for water purification applications.

Thus, there is a need to address the aforementioned problems and other shortcomings associated with the adsorption materials and water filtration technologies. Specifically, there is a need for bio-friendly materials that having improved fluoride and/or arsenic adsorption capacities. These needs and other needs are satisfied by the compositions and methods of the present disclosure.

### SUMMARY

In accordance with the purpose(s) of the invention, as embodied and broadly described herein, this disclosure, in one aspect, relates to a granular composite material, and specifically to a granular composite of organic templated nanometal oxyhydroxide/hydroxide/oxide, and methods for preparing such materials.

In one aspect, the present disclosure provides a method for preparing a granular composite of organic templated nanometal-oxyhydroxide/hydroxide/oxide.

In another aspect, the present disclosure provides a method for preparing a granular composite through an aqueous route comprising a biopolymer and one or more nanometal-oxyhydroxide/hydroxide/oxide particles.

In another aspect, the methods of the present disclosure can obviate the need for elevated temperatures, pressure or external chemical agents in the preparation of granular composite materials.

In yet another aspect, the present disclosure provides a filtration device comprising the inventive nanometal oxyhydroxide/hydroxide/oxide material.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 is a schematic representation of chemical reactions involved in the method for preparation of a granular hybrid composite, in accordance with various aspects of the present invention.

FIG. 2 is a schematic representation of chitosan bound AlOOH particles, in accordance with an embodiment of the present invention, together with micrographs illustrating the pepper corn like shape of the particles.

FIG. 3a illustrates X-ray diffraction (XRD) patterns of an organic template boehmite nanoarchitecture (OTBN), fluoride adsorbed OTBN and chitosan. FIG. 3b illustrates the XRD patterns of OTBN prepared by various starting materials and OTBN dried by various methods.

FIG. 4 illustrates FT-IR spectra of organic template boehmite nanoarchitecture (OTBN) and fluoride adsorbed OTBN.

FIG. 5a illustrates the x-ray photoelectron spectroscopy (XPS) spectra of organic template boehmite nanostructure (OTBN) before and after the adsorption of the fluoride, with FIGS. 5b, 5c, and 5d detailing the aluminum, oxygen, and fluorine regions, respectively.

FIG. 6a illustrates the extent of fluoride adsorption by OTBN as a function of adsorbent dose, and FIG. 6b illustrates the fluoride uptake capacity as a function initial fluoride concentration at an initial fluoride concentration of 10 mg/L and feed water pH of 7±0.2.

FIG. 7a illustrates fluoride uptake capacity of OTBN as a function of time, and FIG. 7b depicts pseudo-second order kinetic plots for the adsorption of fluoride onto OTBN.

FIG. 8a illustrates adsorption capacity of OTBN as a function of adsorbent dose and FIG. 8b illustrates adsorption capacity of OTBN as function of arsenate concentration at an initial arsenate concentration of 1.1 mg/L and feed water pH of 7±0.2.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

### DEFINITIONS

As used in the specification and the appended claims, the singular forms “a,” “an” and “the” include plural referents unless the context clearly dictates otherwise. Thus, for example, reference to “a solvent” can include mixtures of two or more solvents.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

As used herein the term “oxyhydroxide/hydroxide/oxide” can refer to an oxyhydroxide, a hydroxide, an oxide, or any combination thereof. It is not necessary that each of an oxyhydroxide, a hydroxide, and an oxide be present.

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly discussed above, the present disclosure relates generally to a granular composite material. In one aspect, the invention comprises a granular composite of an organic templated nanometal oxyhydroxide/hydroxide/oxide material. In another aspect, such a granular composite can be prepared using a process conducted at least partially in an aqueous medium.

In another aspect, the present disclosure provides methods for the preparation of a granular composite, such as, for example, an organic templated nanometal oxyhydroxide/hydroxide/oxide. In one aspect, the present disclosure provides methods for preparing a granular composition using an aqueous medium, the method comprising a biopolymer and one or more nanometal oxyhydroxide/hydroxide/oxide particles. In a general aspect, the methods of the present invention comprise contacting a metal or metal precursor with a biopolymer and/or biopolymer solution, and then contacting the resulting mixture with a base.

In various aspects, a metal and/or metal precursor can comprise a salt of a metal or a solution thereof. In one aspect, the metal from which a metal and/or metal precursor can comprise aluminum, zinc, manganese, iron, titanium, zirconium, lanthanum, cerium, or a combination thereof. In one aspect, a metal precursor comprises a solution of an aluminum salt comprising aluminum nitrate, aluminum chloride, aluminum sulfate, aluminum isopropoxide, or a combination thereof. In still other aspects, the metal precursor can comprise other metal salts or solutions not specifically recited herein, and the present invention is not intended to be limited to any particular metal precursor. In other aspects, the metal precursor can comprise a mixture of two or more individual metal precursors in any desired ratio, such as, for example, from about 20:1 to about 1:20, for example, about 20:1, 10:1, 5:1, 3:1, 2:1, 1:1, 1:2, 1:3, 1:5, 1:10, or 1:20. In one aspect, the metal precursor comprises aluminum nitrate. In another aspect, the metal precursor comprises a mixture of aluminum and iron salts in a ratio of, for example, about 3:1 (Al:Fe).

The biopolymer can comprise any suitable biopolymer or mixture of biopolymers. In one aspect, the biopolymer can comprise chitosan, banana silk, cellulose fibers, or a combination thereof. In another aspect, the biopolymer or a portion thereof is a flake biopolymer. In another aspect, functionalized forms of the biopolymer can also be used as biopolymer flakes. In other aspects, chitosan flakes can be used as biopolymer flakes. In one aspect, a biopolymer, such as, for example, a biopolymer flake, can be dissolved in a solution of water and/or a solution of water and a mineral acid, such as, for example, HCl, HNO₃ and the like. In such an aspect, the H⁺ ions of the mineral acid can at least partially ionize the biopolymer and dissolve it in the water to obtain biopolymer solution. In one aspect, the biopolymer comprises chitosan. In another aspect, the biopolymer comprises a mixture of cellulose and chitosan.

In one aspect, the metal ions of a metal precursor can interact with a biopolymer through a number of functional groups. The amounts of metal precursor and biopolymer can vary, and any suitable amount for a desired composite can be utilized.

The base of the present invention can comprise any suitable base for use in preparing the inventive granular composites. In one aspect, a base can comprise sodium hydroxide, ammonia, potassium hydroxide, or a combination thereof. In other aspects, other bases or combination of bases and/or solutions thereof can be used, and the present invention is not intended to be limited to any particular base. In one aspect, upon addition of base to a mixture of metal precursor and biopolymer, metal ions present in the resulting metal-biopolymer complex solution can hydrolyze and precipitate as nanometal oxyhydroxide/hydroxide/oxide particles. In one aspect, functional groups associated with a biopolymer, such as chitosan, can enable the formation of metal-oxyhydroxide/hydroxide/oxide, for example, a combination of oxyhydroxide, hydroxide, and oxide, rather than metal hydroxide.

In such an aspect, a semi-solid precipitate comprising nanometal-oxyhydroxide/hydroxide/oxide particles aligned on the chitosan biopolymer can be obtained. In one aspect, the size of the resulting nanometal oxyhydroxide/hydroxide/oxide particles can be in the range of from about 1 nm to about 100 nm. In with yet another aspect, the size of the nanometal oxyhydroxide/hydroxide/oxide particles can be in the range of from about 3 nm to about 10 nm.

In one aspect, the method for preparing the inventive granular composite can be conducted at least partially in an aqueous medium. In another aspect, the method can be conducted in an aqueous medium. In one aspect, the phrase ‘an aqueous medium’ can refer to a medium comprising water, and optionally other aqueous and/or nonaqueous components. In another aspect, the phrase ‘an aqueous medium’ can refer to a medium wherein all components are aqueous or at least partially soluble in water. In still other aspects, other items, such as particulate materials, that can form, for example, a suspension, can be present.

In one aspect, the method can be conducted wherein the temperature of the medium is below about 60° C. for at least a portion of the process. In another aspect, the method can be conducted wherein the temperature of the medium is below about 60° C. during the process.

A metal precursor can be contacted with a biopolymer. In one aspect, the metal precursor or a portion thereof can be in the form of a solution. Upon contacting, the metal precursor and biopolymer can form a metal-biopolymer complex solution. In one aspect, such a complex solution can be subjected to a hydrolysis step wherein the metal precursor or a portion thereof is hydrolyzed by contacted with a base. In one aspect, the base can comprise a solution. In one aspect, the order of contacting can vary. In another aspect, the biopolymer can metal precursor are first contacted, and then the resulting mixture can be contacted with a base or base solution. In other aspects, the degree of mixing can vary, and it is not necessary that the components be thoroughly mixed or that a completely homogeneous mixture be obtained. In another aspect, the components are mixed such that the resulting composition is uniform or substantially uniform. In still another aspect, the components can be vigorously mixed, for example, by stirring, to obtain the desired product.

After contacting with a base, the resulting product can comprise one or more nanometal oxyhydroxide/hydroxide/oxide particles. In one aspect, any of the one or more particles can comprise the same or a different chemical composition and/or structure than any other particles.

In one aspect, a precipitate, such as, for example, a semi-solid precipitate of the one or more nanometal oxyhydroxide/hydroxide/oxide particle-biopolymer composite can be obtained. In such an aspect, the semi-solid precipitate can be subjected to optional filtration and/or drying steps to remove impurities, concentrate the precipitate, and isolate the desired solid nanometal oxyhydroxide/hydroxide/oxide particle-biopolymer composite.

In another aspect, a solid composite produced from the methods described herein can be ground to obtain a granular composite having a particle size and/or particle size distribution suitable for an intended application.

In one aspect, the methods of the present invention do not require at least one of elevated temperature, elevated pressure, and/or external chemical agents to prepare a granular composite. In another aspect, the methods of the present invention do not require elevated temperature, pressure, or external chemical agents to prepare a granular composite. In such aspects, the inventive methods provide substantial improvements over conventional methods known in the art. As the inventive granular composite includes a biopolymer as a component, the method for preparing the composite can be easy, economical, and environment friendly, especially as compared to conventional methods.

In various aspects, the present invention provides methods for preparing granular composites of one or more organic templated nanometal-oxyhydroxide/hydroxide/oxide via an aqueous process. In another aspect, the inventive granular composites can have useful adsorption properties and can be used to remove, for example, fluoride and/or arsenic contaminants from water.

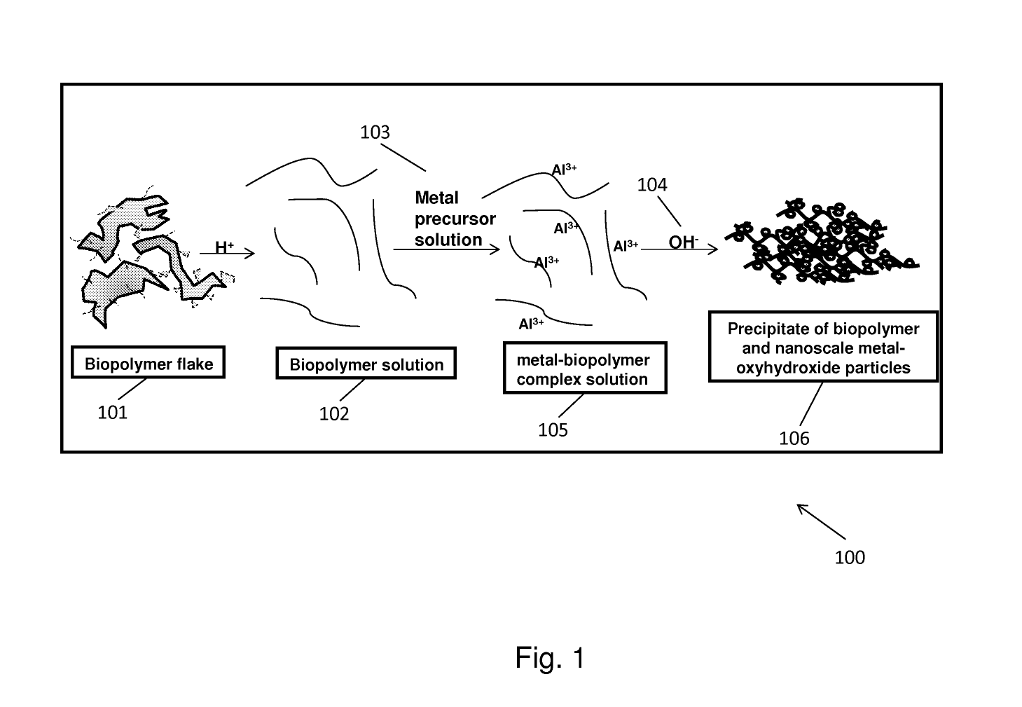

FIG. 1 illustrates an exemplary reaction 100 through which a granular composite of organic templated nanometal-oxyhydroxide/hydroxide/oxide can be obtained. Reaction 100 can be initiated by preparing a biopolymer solution 102 of, for example, a biopolymer flake 101, and then a metal precursor solution 103 can be added to the biopolymer solution 102 to obtain a metal-biopolymer complex solution 105. A base 104 can then be added to the metal-biopolymer complex solution 105 to obtain the composite 106 of biopolymer and nanometal-oxyhydroxide/hydroxide/oxide particles.

In one aspect, the resulting semi-solid precipitate can be filtered and/or dried to remove impurities, to concentrate the precipitate and to obtain a solid metal oxyhydroxide/hydroxide/oxide particle-biopolymer composite. The particular method of drying, if dried, can vary, and the present invention is note intended to be limited to any particular drying method. In various aspects, exemplary drying methods can comprise freeze drying, surface drying, hot air drying, spray drying, vacuum drying, or a combination thereof. In other aspects, other drying technologies known in the art can be used in addition to or in lieu of any other specifically recited methods.

In another aspect, the dried solid precipitate can optionally be ground to a desirable size for an intended application, for example, in the range of from about 0.1 mm to about 3 mm. The resulting granular composite can comprise the metal oxyhydroxide/hydroxide/oxide particles and the biopolymer. In another aspect, the resulting granular composite can consist of the metal oxyhydroxide/hydroxide/oxide particles and the biopolymer. Ina specific aspect, a metal oxyhydroxide, such as, for example, aluminum oxyhydroxide, commonly known as boehmite, can be prepared, wherein the granular composite obtained has an organic template boehmite nanoarchitecture (OTBN).

In another aspect, the reaction 100 can take place at a temperature below about 60° C., for example, about 55, 50, 45, 40, 35, 30, or 25° C. In another aspect, the reaction 100 can take place at a temperature of about 30° C. With the use of bio material and low temperature, the inventive methods described herein can provide easy, economical, and environment friendly methods to prepare composites of organic templated nanometal-oxyhydroxide/hydroxide/oxide.

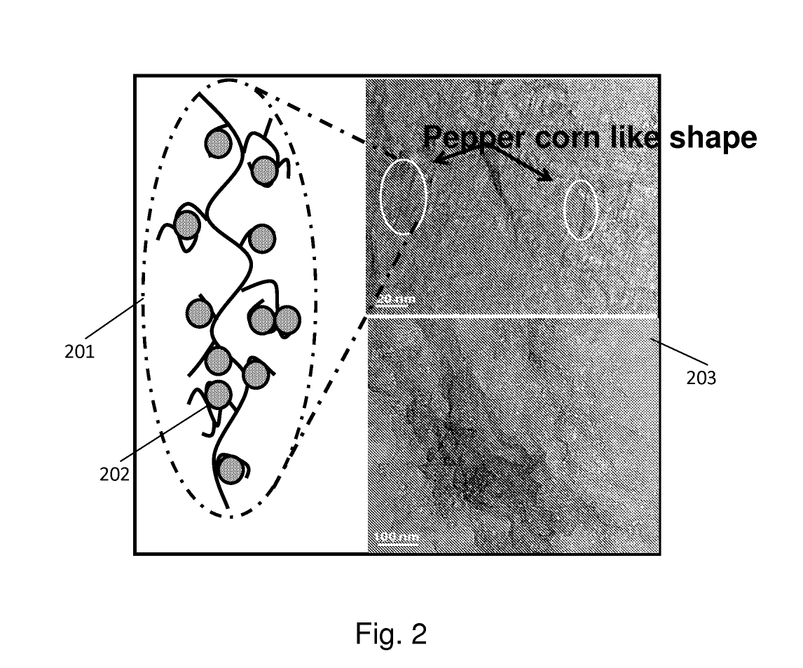

FIG. 2 illustrates an exemplary schematic representation of OTBN comprising chitosan bound aluminum oxyhydroxide particles prepared by the methods of the present invention. As shown in the figure, one or more nanoscale aluminum oxyhydroxide particles 202 can be aligned on the surface of chitosan 201. Transmission electron micrographs 203 illustrate the OTBN at various magnifications. As illustrated in the micrographs, the OTBN samples can exhibit nano-whisker morpholigies. Upon close observation, small particles can be attached to the fibrils, where the attached small particles resemble peppercorns. The fibrils can be organic templates and the particles can comprise AlOOH nanoparticles. Also, as illustrated in the figures, the particles can have nanosize dimensions with diameters of, for example, less than about 5 nm.

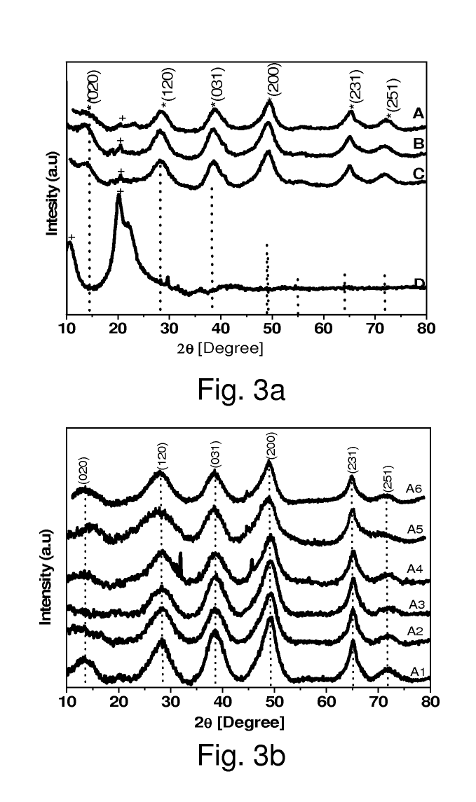

Characterization of organic templated boehmite nanoarchitecture (OTBN) can be explored by various techniques such as x-ray powder diffraction (XRD), Fourier transform infrared (FTIR) spectroscopy, and x-ray photoelectron spectroscopy (XPS), as illustrated in FIGS. 3-5, respectively.

FIG. 3 illustrates the XRD patterns of (A) an exemplary as-synthesized material reacted with 1000 mg/L fluoride; (B) as-synthesized material reacted with 100 mg/L fluoride (C) as-synthesized AlOOH; and (D) chitosan. Dotted lines correspond to the standard reflections of AlOOH. The traces are shifted vertically for clarity. (Label: ‘+’—chitosan; ‘*’—AlOOH). The as-synthesized samples showed peaks corresponding to (020), (120), (013), (200) and (231) and (251) planes (FIG. 3A). All these peaks can be indexed as orthorhombic-AlOOH. The broadened XRD peaks imply that the crystallite size of the OTBN particles is very small. The mean crystallite size calculated from the Scherrer formula shows that nanocrystals are of an average size of about 3.5 nm. The presence of organic template (chitosan) is also clear from the XRD data. Fluoride reacted OTBN samples showed no change in diffraction patterns indicating that the crystal structure is intact even after fluoride adsorption (FIG. 3A). The standard reflections of orthorhombic-AlOOH are also given to validate the structure of the sample. Comparing the XRD positions of the standard sample and the as-synthesized sample, a change in intensity pattern could be seen, which can be ascribed to the effect of the organic template. The intensity of the higher index planes is higher in the nanoscale material. Recent studies on the catalytic activity of metals such as Pt have shown that high-index planes exhibit much higher catalytic activity than that of common and stable, low-index planes.

Apart from the point of view of enhanced catalytic activity, the current synthesis method can yield crystalline nanoscale-AlOOH having good green strength at much lower temperature in comparison to conventional methods. According to the current literature, AlOOH formation is possible only above 373 K, and the prior art syntheses of nanoscale-AlOOH have been done in hydrothermal conditions at temperatures above 373 K.

XRD patterns of the OTBNs prepared at various physical and chemical conditions were recorded in order to understand their effects on crystal structure of OTBN. Some of the XRD patterns recorded are shown in FIG. 3b. FIG. 3b illustrates the XRD patterns of as-synthesized materials through various starting materials: (A1) OTBN prepared using aluminum nitrate and ammonia as the starting materials, (A2) OTBN prepared using aluminum sulfate and ammonia as the starting materials, (A3) OTBN prepared using aluminum nitrate and sodium hydroxide as the starting materials, (A4 to A6) OTBN prepared using aluminum chloride and NaOH as the starting materials. All the materials except A5 and A6 were dried at 60 degree centigrade in oven. A5 was dried at room temperature and A6 was dried at 120 degree centigrade in oven. The data shows the formation of AlOOH with all the aluminum precursors and temperature range (25 to 130 degree centigrade) studied. The crystallographic structures obtained were seemingly identical.

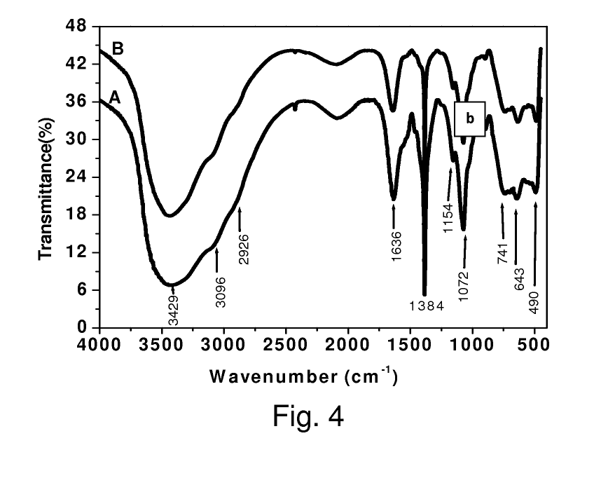

FIG. 4 illustrates FT-IR spectra of (A) the as-synthesized OTBN and (B) fluoride adsorbed OTBN. All the absorption bands are consistent with literature values and give additional evidence for the formation of γ-AlOOH. The bands at 1072 and 1154 cm⁻¹ are assigned to the symmetric and asymmetric stretching frequencies of Al—O—H of boehmite, respectively. The bands at 3096 and 3312 cm⁻¹ are assigned to Al—OOH stretching vibrations. The band at 1636 cm⁻¹ is assigned to the bending modes of adsorbed water and the broad band at 3429 cm⁻¹ is due to the O—H stretching mode of adsorbed water.

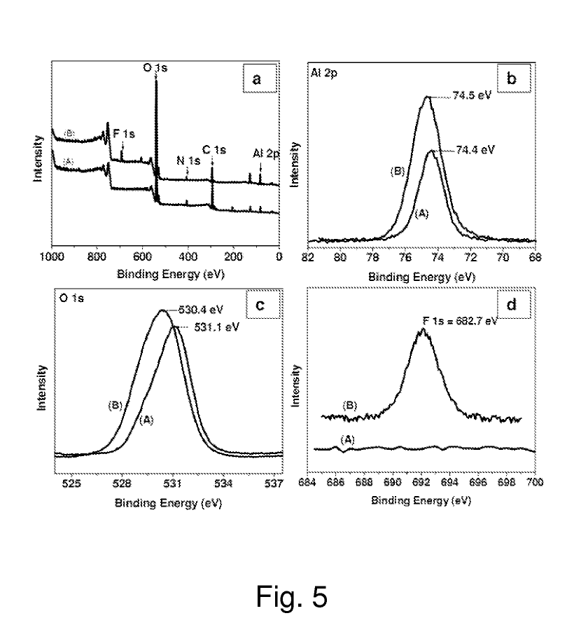

FIG. 5 illustrates the X-ray photoelectron spectroscopy (XPS) survey spectra of OTBN before and after the adsorption of the fluoride. Trace (A) and (B) in the FIG. 5(a-d) represent as-prepared OTBN and fluoride adsorbed OTBN respectively. FIG. 5(a) shows the survey spectra and (b,c,d) show the spectra of various regions of interest. These spectra confirm the existence of adsorbed fluoride along with the key elements aluminum and oxygen. For understating the chemical form of the pristine and fluoride adsorbed materials, detailed scans of specific regions of key elements (Al 2p, O 1s) and adsorbed ion (F 1s) were carried out and are shown in FIG. 5. The XPS spectrum of the aluminum 2p level shows a peak at 74.4 eV, which is in agreement with reported values of aluminum in AlOOH. Thus, in one aspect, fluoride adsorption does not affect the position of aluminum, but a reduction in the surface positive charge can be seen in the oxygen of is orbital, as a result of which it appears at a lower binding energy.

In another aspect, the granular composite of organic templated nanometal-oxyhydroxide prepared by the methods of the present invention can exhibit fluoride, arsenic and/or pathogen adsorption capability from water. In one aspect, a granular composite can have a fluoride adsorption capacity in excess of about 50 mg/g at an initial fluoride concentration of about 10 mg/l, and/or have an arsenic adsorption capacity in excess of about 19 mg/g at an initial arsenate concentration of about 1.0 mg/l.

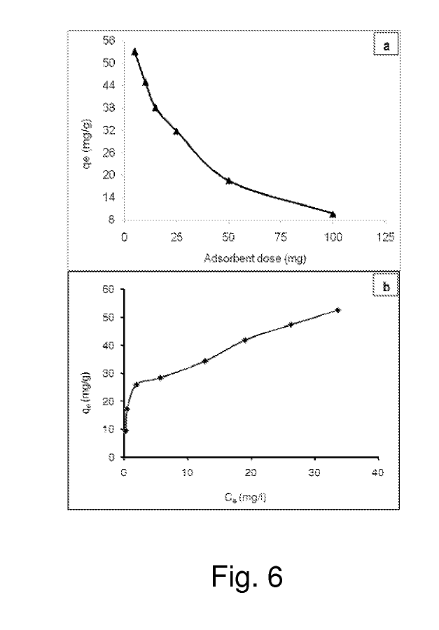

In another aspect, the fluoride and/or arsenic adsorption rates of the composite of organic templated nanometal-oxyhydroxide prepared by the methods of present invention are discussed in FIGS. 6-8.

FIG. 6a illustrates the extent of fluoride adsorption by OTBN as a function of adsorbent dose. The working volume of the contaminated water was taken to be 100 ml and the quantity of adsorbent dose is varied between 2.5 mg to 100 mg. The OTBN prepared through various starting materials were also tested to assess their capability to remove fluoride. As expected, the amount of fluoride adsorbed increased with increase in material dose from about 2.5 mg to about 50.0 mg and became more or less constant for further increase in dose. As evident from the data, the fluoride concentration reduced to a value as low as about 0.5 mg/L from an initial concentration of about 10 mg/L at optimum adsorbent dose. When the OTBN dose was further increased, there was less proportionate increase in adsorption because of the limitation of fluoride ions as compared to the adsorption sites available for the reaction. From these results it is observed that at about 10 mg/L fluoride concentration and neutral pH, the OTBN sample can remove about 53 mg/g of fluoride. This is considerably higher than the commercially available alumina or AlOOH based nanomaterials tested so far. A recent attempt to remove fluoride from water using nanoscale-AlOOH showed a removal capacity of 3.26 mg/g, which is around 16 times less in capacity compared to the inventive OTBN sample prepared using the methods of present invention.

FIG. 6b illustrates the fluoride uptake capacity as a function of initial fluoride concentration. The working volume of the contaminated water was taken to be 100 ml and the initial fluoride concentration was varied between 5-60 mg/L. An increase in fluoride uptake capacity was observed with increase in initial fluoride concentrations and an uptake capacity in excess of about 50 mg/g was observed at initial fluoride concentration of 60 mg/L (Cₑ=33.5 mg/L).

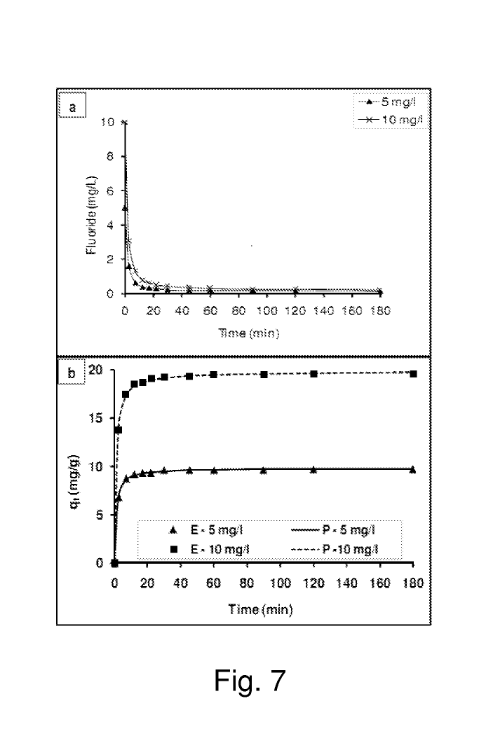

FIG. 7a illustrates fluoride uptake capacity of OTBN as a function of time. The working volume of the contaminated water was taken to be 100 ml and quantity of adsorbent used is 50 mg. Results show that fluoride uptake with OTBN sample prepared using the method of present invention is very fast and most of the removal takes place in the first 10 minutes of contact and the equilibrium is reached in 60 min. The fluoride uptake kinetics observed in the case of OTBN is much superior to the commercially available alumina and many other adsorbents used for scavenging fluoride, which has large implications in practical applications.

To understand the process kinetics better, kinetic data of fluoride adsorption by OTBN was analyzed with various reaction kinetic models, including Lagergren pseudo-first-order, and Ho's pseudo-second-order reaction rate models. While not wishing to be bound by theory, mathematical representations of these models are given in equations 1 and 2.

Pseudo-first-order equation:

qₜ=qₑ(1−e^{-K}^{₁}^{t}) (1)

Pseudo-second-order equation:

$${q}_{t} = \frac{{q}_{e}^{2} {k}_{2} t}{1 + {q}_{e} {k}_{2} t} \qquad ( 2 )$$

where qₜ is the amount of fluoride removed from aqueous solution at time t (mg/g); qₑ is the amount of fluoride removed from aqueous solution at equilibrium (mg/g); K₁ is the pseudo-first-order rate constant of adsorption (l/min); K₂ is the pseudo-second-order rate constant of adsorption (g/mg·min); and t is the time (min).

The best-fit model plots (pseudo-second-order reaction model) along with experimental plots are illustrated in FIG. 7b. The kinetic rate constant, K₂ for 10 mg/L and 5 mg/L of fluoride were calculated to be 0.049 and 0.098 g/mg·min, respectively.

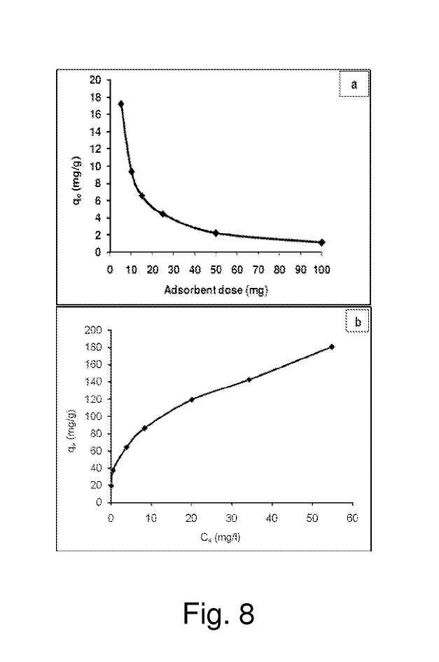

FIG. 8a illustrates the extent of arsenic adsorption by OTBN as a function of adsorbent dose. OTBN dose was varied over a range of 5 to 100 mg. The working volume of the contaminated water was taken to be 100 ml. Studies were conducted with an initial arsenic concentration of about 1.1 mg/L and at pH of 7±0.2. As evident from the data, the OTBN (25 mg) could reduce the arsenic concentration to a value below detectable limits of current techniques, such as inductively coupled plasma (ICP-OES) (<0.05 mg/L).

In another aspect, an equilibrium adsorption study of arsenic by OTBN was carried out at 30±2° C. and neutral pH. The initial arsenic concentrations were varied over a wide range (5-100 mg/L). The working volume of the contaminated water was taken to be 100 ml. The results obtained from this study are shown in FIG. 8b. As evident from the data, the uptake capacity increased with increase in arsenic concentrations. An adsorption capacity of 183 mg/g is observed at initial arsenic concentration of 100 mg/L. This shows that the OTBN prepared using the method of the present invention has high affinity to arsenic and is better than any other aluminum based material reported for arsenic removal at similar equilibrium concentrations studied.

In yet other aspects, the present invention provides methods for using a granular composite, such as, for example, to remove at least a portion of fluoride and/or arsenic that can be present in a water source. In such an aspect, the present invention can serve as an adsorption media in a water purification technology, such as, for example, a water filter. In various aspects, the inventive granular composite can reduce the concentration of fluoride, arsenic, pathogens, and/or other contaminants in a water source.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

This example describes low temperature synthesis of nanoscale-AlOOH through a simple soft chemistry route. The synthesis procedure comprises mixing an aluminum precursor solution with chitosan (dissolved in 1-5% glacial acetic acid or HCl or combination thereof) with vigorous stirring. In a general procedure, a solution of aluminum precursor, such as aluminum nitrate was added slowly into the chitosan solution with vigorous stirring for 60 minutes and was kept overnight without agitation. Aqueous ammonia or NaOH solution was slowly added into the metal-chitosan solution with vigorous stirring to facilitate the precipitation of the metal-chitosan composites (pH 7-8.0). All these steps were carried out at temperature below 30° C. Stirring was continued for two hours. The precipitate was filtered, washed to remove any unwanted impurities, converted in the shape of beads and dried at various conditions.

### Example 2

This example describes the use of other biopolymers for the preparation of OTBN through a simple soft chemistry route. The synthesis procedure comprises mixing the aluminum precursor solution with cellulose with vigorous stirring. In a general procedure, a solution of aluminum precursor such as aluminum nitrate was added slowly into the polymer solution with vigorous stirring for 60 minutes and was kept overnight without agitation. Aqueous ammonia or NaOH solution was slowly added into the metal-cellulose solution with vigorous stirring to facilitate the precipitation of the metal-cellulose composites (pH 7-8.0). All these steps were carried out at temperature below 30° C. Stirring was continued for two hours. The precipitate was filtered, washed to remove any unwanted impurities, converted in the shape of beads and dried at various conditions.

### Example 3

This example describes the use of a mixture of biopolymers for the preparation of OTBN through a simple soft chemistry route. The biopolymers used for the study are chitosan and cellulose. Cellulose powder was added to the chitosan solution (chitosan dissolved in 1% acetic acid). The weight ratio of chitosan to cellulose is 1:1. Further, aluminum nitrate solution was added slowly into the biopolymer solution with vigorous stirring for 60 minutes and was kept overnight without agitation. Aqueous ammonia or NaOH solution was slowly added into the metal-chitosan solution with vigorous stirring to facilitate the precipitation of the metal-cellulose-chitosan composites (pH 7-8.0). All these steps were carried out at temperature below 30° C. Stirring was continued for two hours. The precipitate was filtered, washed to remove any unwanted impurities, converted in the shape of beads and dried at various conditions.

### Example 4

This example describes the low temperature synthesis of metal ion doped nanoscale-AlOOH through a simple soft chemistry route. A mixture of aluminum nitrate and ferric nitrate is prepared in the molar ratio of 3:1 (Al:Fe). The mixture is then slowly added into the chitosan solution (prepared in 1-5% nitric acid) with vigorous stirring for 60 minutes and was kept overnight without agitation. Aqueous ammonia or NaOH solution was slowly added into the metal-chitosan solution with vigorous stirring to facilitate the precipitation of the metal-chitosan composites (pH 7-8.0). All these steps were carried out at temperature below 30° C. Stirring was continued for two hours. The precipitate was filtered, washed to remove any unwanted impurities, converted in the shape of beads and dried at various conditions.

### Example 5

This example describes the variation in the size of nanoscale-AlOOH by varying the ratio of Al:chitosan. The quantity of chitosan in the OTBN is increased to 40%. The presence of higher quantity of chitosan helps in further reducing the size of the nanoscale-AlOOH. A solution of aluminum precursor such as aluminum nitrate was added slowly into the chitosan solution with vigorous stirring for 60 minutes and was kept overnight without agitation. Aqueous ammonia or NaOH solution was slowly added into the metal-chitosan solution with vigorous stirring to facilitate the precipitation of the metal-chitosan composites (pH 7-8.0). All these steps were carried out at temperature below 30° C. Stirring was continued for two hours. The precipitate was filtered, washed to remove any unwanted impurities, converted in the shape of beads and dried under various conditions.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-52. (canceled)

53. A method for preparing a granular composite in an aqueous medium comprising a biopolymer and one or more nanometal-oxyhydroxide/hydroxide/oxide particles, the method comprising the steps of:
a. contacting a metal precursor with a biopolymer to obtain a metal-biopolymer complex; and then
b. contacting the metal-biopolymer complex with a base to obtain one or more nanometal oxyhydroxide/hydroxide/oxide particles.

54. The method of claim 53, wherein steps a and b are performed at a temperature of below about 60° C.

55. The method of claim 53, further comprising, after b,
c. mixing the metal-biopolymer complex to produce a semi-solid precipitate;
d. filtering the semi-solid precipitate;
e. drying the semi-solid precipitate to produce a dried particle-biopolymer composite; and
f. grinding the dried particle-biopolymer composite to form a granular composite.

56. The method of claim 53, wherein the biopolymer comprises chitosan, banana silk, cellulose, or a combination thereof.

57. The method of claim 53, wherein at least a portion of the nanometal oxyhydroxide particles have a crystalline structure.

58. The method of claim 53, wherein the metal precursor comprises a salt of aluminum, zinc, manganese, iron, titanium, zirconium, lanthanum, cerium, or a combination thereof.

59. The method of claim 53, wherein the metal precursor comprises titanium dioxide.

60. The method of claim 53, wherein the metal precursor comprises titanium dioxide in the form of anatase.

61. The method of claim 53, wherein the metal precursor comprises granular titanium dioxide.

62. The method of claim 53, wherein steps a-b are performed at a temperature of from about 20° C. to about 60° C.

63. The method of claim 53, wherein steps a-b are performed at about room temperature.

64. The method of claim 53, wherein the size of the granular composite of metal oxyhydroxide/hydroxide/oxide particles-biopolymer is in the range of from about 0.1 mm to about 3 mm.

65. The method of claim 55, wherein the granular composite is suitable for use in the removal of contaminants from water.

66. The method of claim 65, wherein contaminants comprise arsenic, an arsenic containing compound, or a combination thereof.

67. The method according to the claim 55, wherein the granular composite has an arsenic adsorption capacity in excess of 19 mg/g at an initial arsenate concentration of 0.1 to 1 mg/L.

68. A granular composite comprising a biopolymer and one or more nanometal-oxyhydroxide/hydroxide/oxide particles prepared by a process conducted in aqueous medium comprising the steps of:
a. contacting a metal precursor solution with the biopolymer to obtain a metal-biopolymer complex solution;
b. hydrolyzing the metal precursor by adding a base solution into the metal-biopolymer complex solution with vigorous stirring to obtain the one or more nanometal oxyhydroxide/hydroxide/oxide particles;
c. obtaining a semi solid precipitate of the one or more metal oxyhydroxide/hydroxide/oxide particles-biopolymer composite by vigorous stirring of the metal-biopolymer complex solution;
d. filtering the semi solid precipitate to remove impurities and to concentrate the semi solid precipitate;
e. drying the semi solid precipitate of the metal oxyhydroxide/hydroxide/oxide particles-biopolymer composite to obtain a solid metal oxyhydroxide/hydroxide/oxide particles-biopolymer composite; and
f. grinding the solid metal oxyhydroxide/hydroxide/oxide particles-biopolymer composite to obtain granular composite comprising the metal oxyhydroxide/hydroxide/oxide particles and the biopolymer
whereby, the steps a-f are performed at a temperature below 60 degree centigrade.

69. The granular composite of claim 68, wherein the size of the granular composite of nanometal oxyhydroxide/hydroxide/oxide-biopolymer is in the range of from about 0.1 mm to about 3 mm.

70. The granular composite of claim 68, wherein the granular composite has a fluoride adsorption capacity in excess of 50 mg/g at an initial fluoride concentration of 1 to 10 mg/L.

71. The granular composite of claim 68, wherein the granular composite has an arsenic adsorption capacity in excess of 19 mg/g at an initial arsenate concentration of 0.1 to 1.0 mg/L.

72. The granular composite of claim 68, wherein the granular composite is used as a desiccant, a catalyst, an insulation coating, or a combination thereof.

73. A method for reducing an impurity in a water sample, the method comprising contacting the granular composite of claim 68 with a water sample comprising one or more contaminants.

74. The method of claim 73, wherein the one or more contaminants comprises an inorganic contaminant.

75. The method of claim 73, wherein the one or more contaminants comprises fluoride and/or a fluorine containing compound, arsenic and/or an arsenic containing compound, or a combination thereof.

76. The method of claim 73, wherein the one or more contaminants comprises arsenic, an arsenic containing compound, or a combination thereof.

77. The method of claim 73, wherein upon contacting, at least a portion of the one or more contaminants is adsorbed by the granular composite.

78. The method of claim 73, wherein after contacting, at least one of the one or more contaminants is present at a reduced concentration.
